(19) United States
(12) Patent Application Publication
(10) Pub. No.: US 2024/0198907 A1
(43) Pub. Date: Jun. 20, 2024

(54) VEHICLE MIRROR SYSTEM

(71) Applicant: Matt Risley, Phoenix, AZ (US)

(72) Inventor: Matt Risley, Phoenix, AZ (US)

(21) Appl. No.: 18/512,421

(22) Filed: Nov. 17, 2023

Related U.S. Application Data
(60) Provisional application No. 63/426,569, filed on Nov. 18, 2022.

(51) Int. Cl. B60R 1/06

(52) U.S. Cl. CPC B60R 1/06

(57) ABSTRACT

A mirror system, comprises a main mirror housing; a main mirror coupled to a first side of a main mirror housing; a mirror stem having a distal end coupled to a surface of a vehicle; a backing clamp between a proximal end of the mirror stem and a second side of the main mirror housing, the backing clamp including a pocket aligned with a threaded hole at the distal end of the mirror stem, the backing clamp permitting the main mirror to rotate about the mirror stem; a secondary mirror housing; and a secondary mirror coupled to a first side of the secondary mirror housing.

### RELATED APPLICATIONS

This application claims the benefit of the earlier filing date of U.S. Provisional Patent Application No. 63/426,569, filed Nov. 18, 2022 and entitled “Vehicle Mirror System,” the entirety of which is incorporated herein by reference.

### FIELD OF THE INVENTION

The inventive concepts relate generally to a vehicle mirror system, and more specifically a mirror system that allows an operator to adjust the mirror manually to maximize the viewing area behind and/or to the side of the operator while minimizing blind spots.

### BACKGROUND

Many vehicles, in particular, motorcycles, utility terrain vehicles (UTVs), all terrain vehicles (ATVs), marine craft, race cars, vintage automobiles, and so on, rely on manual rear view mirrors mounted to at least one side of the vehicles. These mirrors have no electronics that allow them to be adjusted by the vehicle operator or passenger. As shown in FIG. 1A, a conventional mirror system 100 includes a mirror stem 11, mirror body 12, a mirror (not shown) positioned in the mirror body 12, and a ball stud 13 configured to allow a user to perform an adjustment of the mirror using a tension adjuster. Alternatively, as shown in FIG. 1B, a conventional mirror system 150 may include the ball stud 53 integrated into the stem 51. The ball stud 53 and/or mirror body 52 can be tightened to hold the mirror in place according to a desired angle adjusted by the vehicle operator. In both configurations, a tension adjuster is used to apply friction about the ball stud 13, 53. Also, in both configurations, the mirrors can be adjusted radially, for example, by the operator rotating the mirror about the ball stud.

While a mirror can be rotated, oriented, or the like to a position desired by the operator, the operator's view can be limited or obscured due to the multitude of possible vehicle components impeding the view such as the handlebar, chassis, rear bumper, or the operator/driver or passenger.

In addition, over time the locking components about the ball stud of a conventional mirror can deteriorate and reduce the ability of the mirror to be locked in place after its initial adjustment. When this happens, the mirror will fall or hang from the stem this will cause all initial adjustments to come loose. The operator will not be able to see the correct initial view adjustment as described above and it is possible that the mirror rotates to the point of disturbing operator control. An unintended loosening of the mirror may occur causing it to move out of position. In some cases, such as with motorcycles, a loose mirror may interfere with proximal clutch or brake handles, or the accelerator which can be dangerous to the vehicle operation.

In addition, as shown in FIG. 1B, the ball stud 53 of a conventional mirror system 150 is non-serviceable part because it is confined in the mirror housing 52 or is integral with the stem 51 and cannot be removed from the housing 52. In the mirror system 13 of FIG. 1, on the other hand, the ball stud 13 is removable from the mirror stem 11 but not the housing 12. In both configurations, mirror components such as bolts, rotatable head of the ball stud 112, can wear down over time due to friction, which requires an expensive replacement of the entire mirror system 100, 150.

### BRIEF DESCRIPTION OF THE DRAWINGS

FIG. 1A is a perspective view of a conventional vehicle rear-view mirror;

FIG. 1B is a perspective view of another conventional vehicle rear-view mirror;

FIG. 2A is a perspective view of a vehicle mirror system in a closed position, in accordance with some embodiments of the present inventive concepts.

FIG. 2B is a front view of the vehicle mirror system of FIG. 2A.

FIG. 2C is a bottom view of the vehicle mirror system of FIGS. 2A and 2B.

FIG. 3A is a front view of the vehicle mirror system of FIGS. 2A-2E in an open position.

FIG. 3B is a rear view of the vehicle mirror system of FIGS. 2A-2E in a closed position and FIG. 3A in an open position.

FIG. 3C is a bottom perspective view of the vehicle mirror system of FIGS. 3A and 3B.

FIG. 4A is a front view of the vehicle mirror system of FIGS. 2A-3C in an extended position.

FIG. 4B is a rear view of the vehicle mirror system of FIGS. 2A-2E in a closed position, FIGS. 3A-3C in a closed position, and FIG. 4A in an extended position.

FIG. 4C is a top perspective view of the vehicle mirror system of FIGS. 4A and 4B.

FIGS. 5A and 5B are exploded views of the vehicle mirror system of FIGS. 2A-4C.

FIG. 6A is a view of the vehicle mirror system of FIGS. 2A-5 coupled to a motorcycle, in accordance with some embodiments of the present inventive concepts.

FIG. 6B is a view of the vehicle mirror system of FIGS. 2A-5 coupled to an automobile, in accordance with some embodiments of the present inventive concepts.

FIG. 7A is a top view of a backing clamp coupled to a stem of a vehicle mirror system by a coupling assembly, in accordance with some embodiments.

FIG. 7B is a perspective view of the backing clamp, stem, and coupling assembly of FIG. 7A.

FIG. 7C is a perspective view and corresponding close-up view of the coupling assembly and stem of the vehicle mirror system of FIGS. 7A and 7B.

FIGS. 8A and 8B are exploded views of the coupling assembly, stem, and main mirror housing of a vehicle mirror system, in accordance with some embodiments.

FIG. 9 is a perspective view of a vehicle mirror system, in accordance with other embodiments of the present inventive concepts.

FIG. 10A is a rear view of a vehicle mirror system in a closed position, in accordance with other embodiments of the present inventive concepts.

FIG. 10B is a rear view of the vehicle mirror system of FIG. 10A in an open position.

FIGS. 11-13 are various views of a vehicle mirror system, in accordance with other embodiments of the present inventive concepts.

### DETAILED DESCRIPTION OF THE EMBODIMENTS

In the following description, specific details are set forth although it should be appreciated by one of ordinary skill that the systems and methods can be practiced without at least some of the details. In some instances, known features or processes are not described in detail so as not to obscure the present invention.

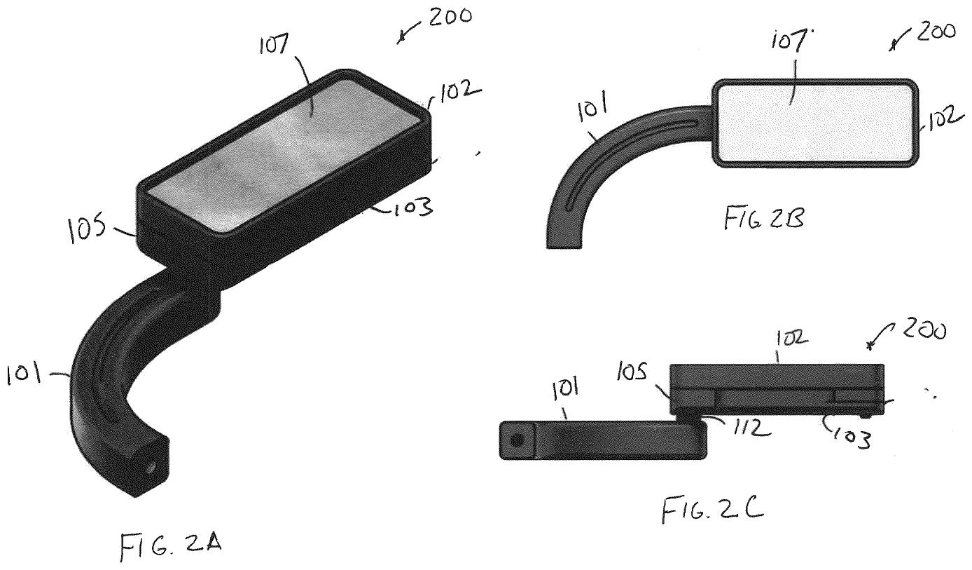

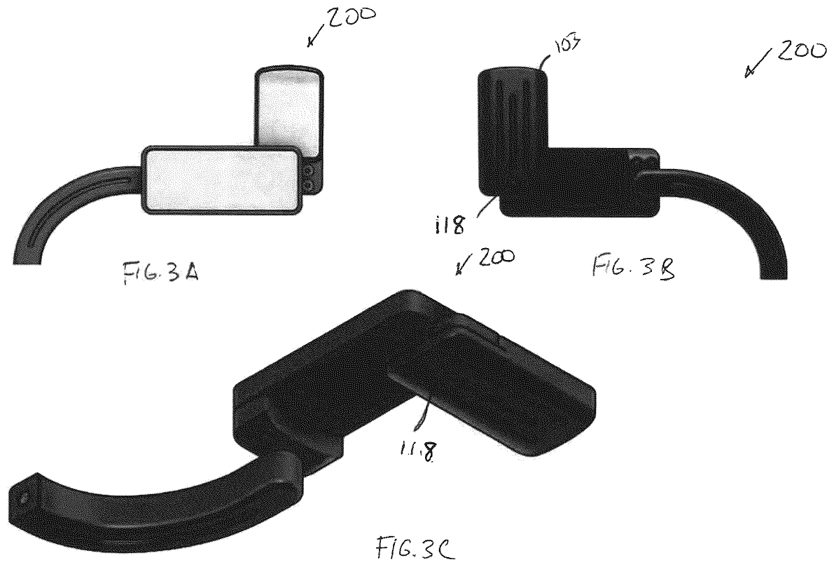

Referring to FIGS. 2A-2C, a vehicle mirror system 200 includes a stem 101, a main mirror housing 102, a secondary mirror housing 103, a backing clamp 105, a main mirror reflector element 107 positioned in the main mirror housing 102, and a ball stud 112. The vehicle mirror system 200 is constructed arranged as a driver-side exterior mirror assembly or a passenger-side mirror assembly that is operable to adjust and improve a rearward field of view of the vehicle operator.

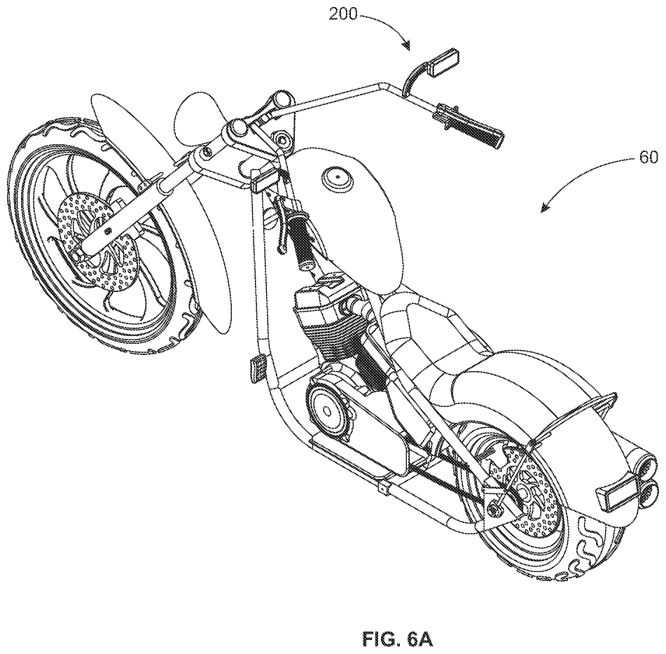

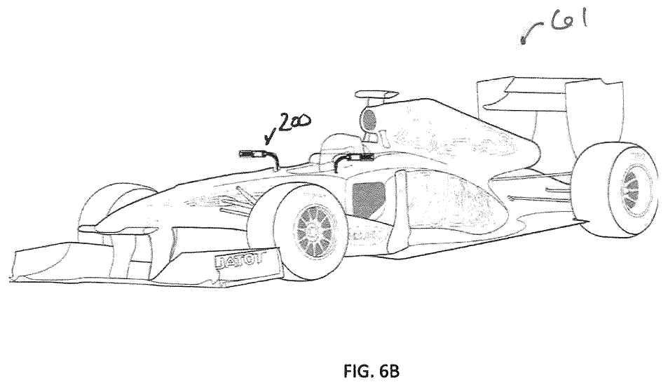

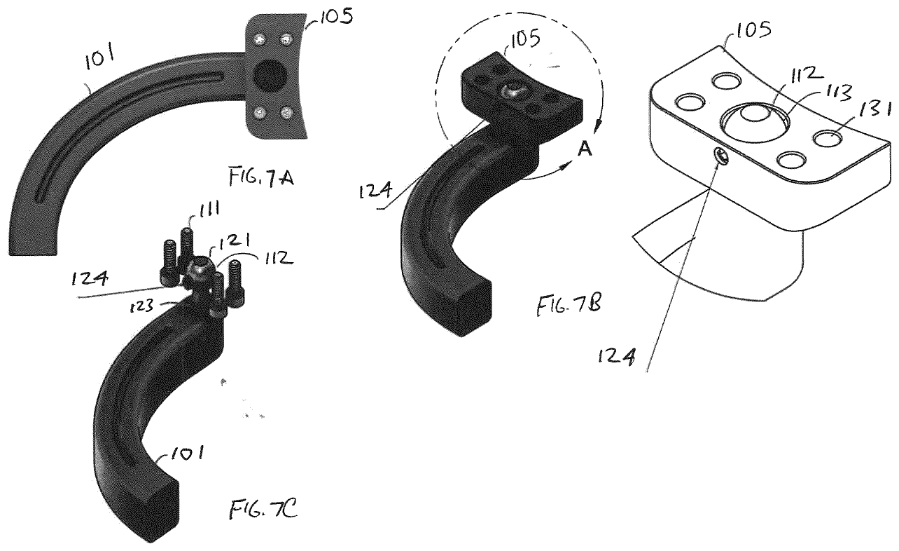

The stem 101 has a proximal end constructed and arranged for coupling to a surface of a coupled to a surface of a vehicle operated by a user. In one example, as shown in FIG. 6A, the vehicle mirror system 200 can be coupled to a handlebar of a motorcycle 60. In another example, as shown in FIG. 6B, the vehicle mirror system 200 can be coupled to the body of a racecar 61. In other examples (not shown), the vehicle mirror system 200 can be coupled to an all-terrain vehicle (ATV), boat, airplane, or other manned vehicle.

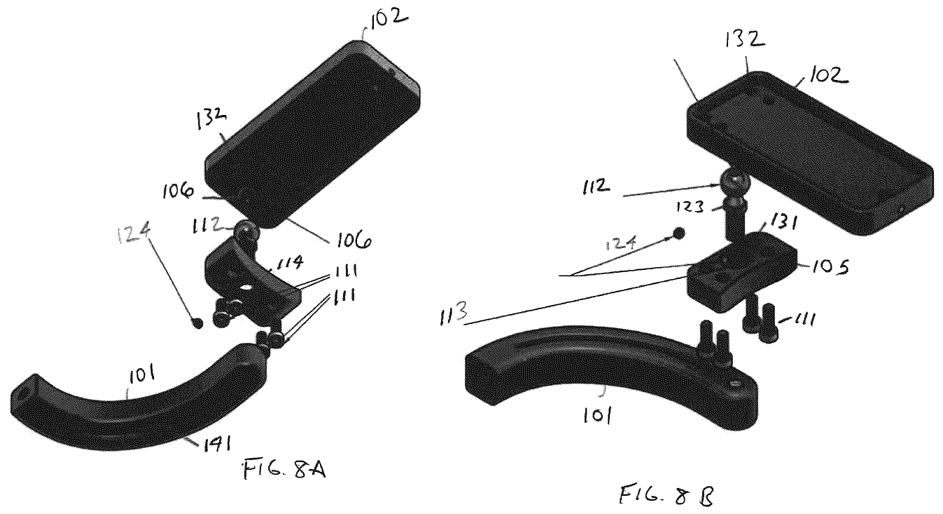

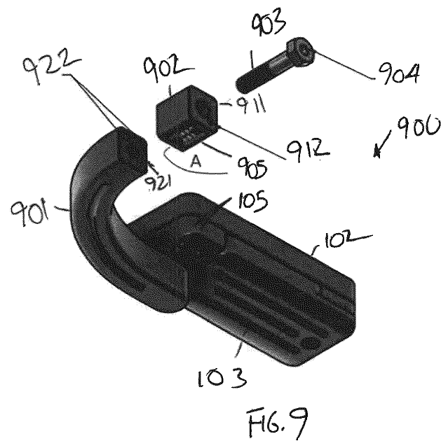

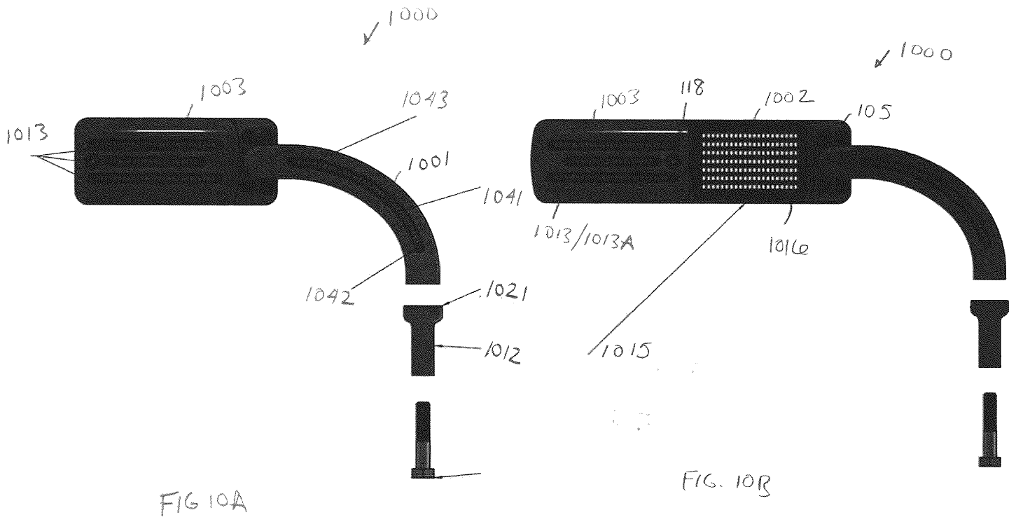

The ball stud 112 is coupled between the distal end of the stem 101 and the backing clamp 105, which in turn is coupled to a surface of the main mirror housing 102. For example, as shown in FIGS. 7A-8B, the ball stud 112 may extend from a pocket 113 in the backing clamp 105 to a threaded hole at the distal end of the mirror stem 101. The main mirror reflector element 107, also referred to as a main mirror, is positioned in the main mirror housing 102.

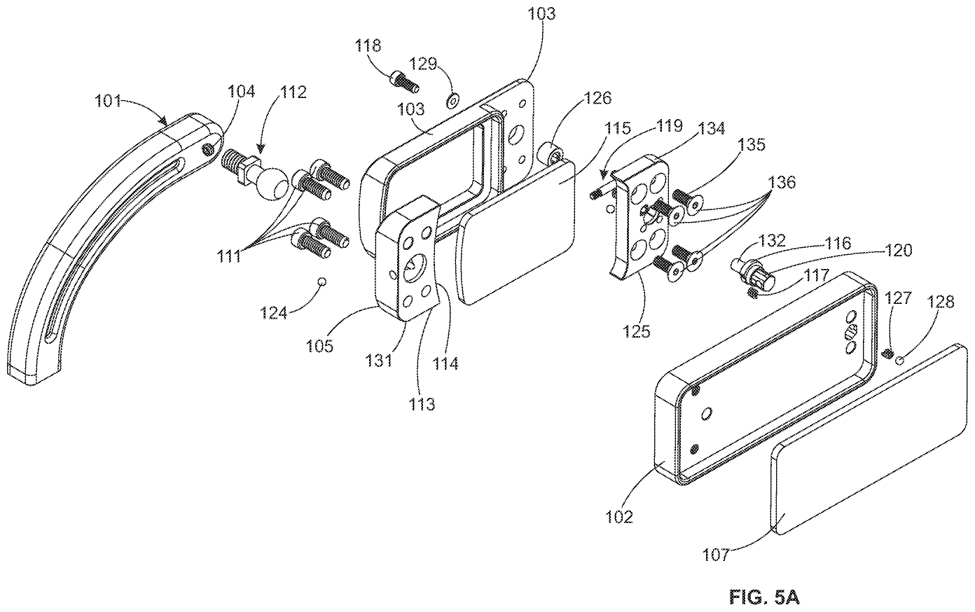

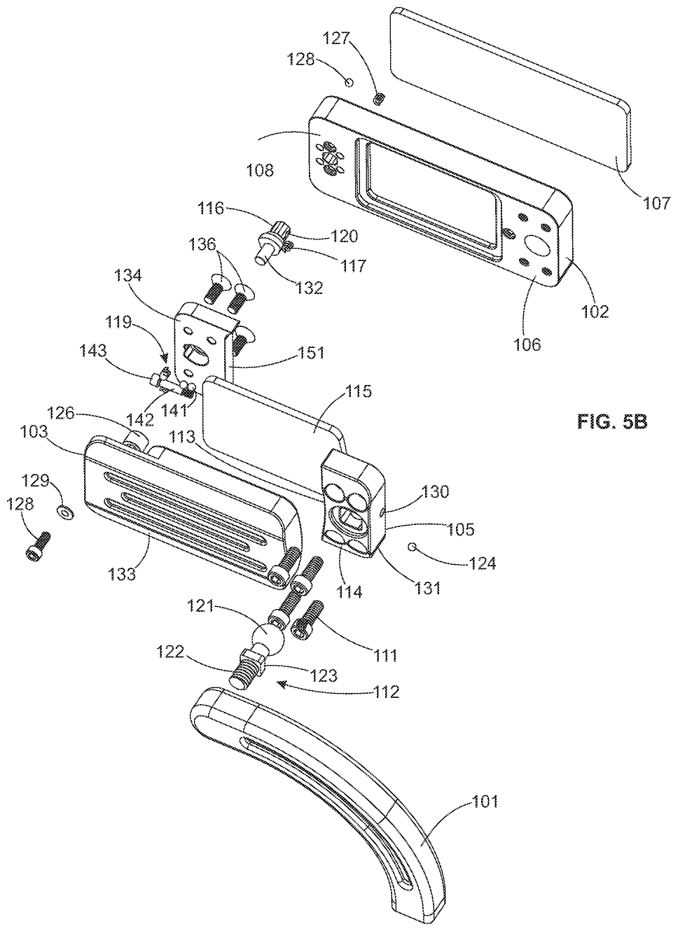

As shown in FIGS. 5A and 5B, the ball stud 112 may include a spherical shaped head 121, a threaded shank 122, and a polygon, e.g., hexagon, nut portion 123 between the head 121 and the shank 122. When assembled, the backing clamp 105 is attached to the main mirror housing 102 and is configured to position the ball stud 112 in the pocket 113, which may be a bore, recess, or cavity, of the backing clamp 105 and to abut the housing 102 so that the spherical shaped head 121 of the ball stud 112 extends from the stem 101 and remains in the pocket 113 during operation due to the coupling between the backing clamp 105 and the housing 102. The backing clamp 105 has a hole 114 extending from the pocket 113 through the thickness of the backing claim 105. A threaded shank 122 of the ball stud 112 can be inserted through a threaded hole 104 in the stem 101, for example, shown in FIGS. 5A and 7A-7C. A wrench or other tool can be positioned about the bolt nut 123 and apply a rotational force to screw the shank 122 into the stem 101.

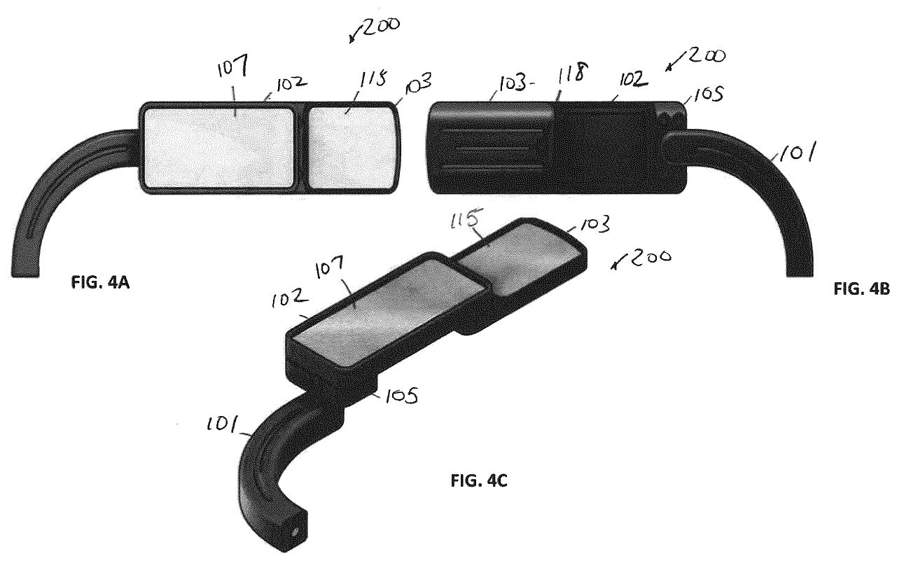

The secondary mirror housing 103 is constructed and arranged for positioning a secondary mirror 115 and for coupling to an underside of the main mirror housing 102. As shown in FIG. 2C, the secondary mirror housing 103 can have a same or similar thickness as the backing clamp 105 and can extend in a same planar direction as the backing clamp 105. As shown in FIGS. 3A-3C and 4A-4C, a main mirror reflector element 107 can be positioned in the main mirror housing 102. The secondary mirror housing 103 and mirror 115 can rotate about an axis formed at least on part by a bolt 118 extending through holes in the secondary mirror housing 103 and main mirror housing 102, respectively. Accordingly, a proximal end of the main mirror housing 102 as well as the secondary mirror housing 103 and backing clamp 105 can pivot about the stem 101, and the secondary mirror housing 103 can independently pivot about a distal end of the main mirror housing 102, for example, by way of elements described with respect to FIG. 5A.

A feature of the vehicle mirror system 200 is that the backing clamp 105 configuration allows the ball stud 112 to be removed for servicing, for example, replacement, cleaning, and so on. For example, the backing plate 105 can be separated from the main mirror housing 102 by unthreading or otherwise removing the clamp fasteners 111, e.g., bolts, from the corresponding holes in the main mirror housing 102. After the main mirror housing 102 is removed, the head 121 of the ball stud 112 in the pocket 113 is exposed. The ball stud 112 can be unthreaded or otherwise removed from the stem 101 using a wrench or other tool positioned about the bolt nut 123 and apply a rotational force to unscrew the shank 122 from the stem 101. The ball stud 112 can then be removed from the pocket 113 in the backing plate 105.

The addition of the mirror backing clamp 105 can vary in thickness externally or internally to provide as much surface area around the ball stud 112 as the designer chooses or whatever any testing may show. The additional surface area translates to more surface area directly in contact with two pockets each applying a force against the ball stud 112 permitting a distribution of forces against the ball stud 112. Conventional mechanical configurations include the ball stud against a single pocket and therefore, less contact surface area and a greater force applied against the ball stud resulting in more friction and less longevity. As described above, the mirror backing clamp 105 fastens to the main mirror housing 102 and clamps the ball stud 112 in between. The ball stud 112 can still be removed from the mirror stem 101 as described above; however, the mirror backing clamp 105 can be disassembled from the main mirror housing. When removed, the mirror backing clamp 105 and ball stud 112 can be repaired or replaced individually, as a set or by assembly.

FIGS. 5A and 5B are exploded views of the vehicle mirror system 200 of FIGS. 2A-4C.

In some embodiments, as also shown in FIGS. 7B and 7C, the ball stud head 121 and mirror backing clamp 105 each has a threaded hole for receiving a rotational lock element 124, also referred to as a ball stud adjustment lock or friction lock, which may be a set screw or the like. In some embodiments, the set screw is milled to be circular on the end in the mirror backing clamp to provide a locking action on the ball stud 112. When used, the ball stud adjustment lock 124 removably extends into the pocket 113 of the backing plate 105. The ball stud 112 is held in place and oscillates between the pocket 113 of the backing clamp 105 and the pocket 106 of the main mirror housing 102. The pockets 106, 113 at least partially surrounding the ball stud head 121 allows for a rotational movement of the ball stud 112, but the lock element 124 can reduce the freedom of rotation by directly abutting and applying a force to the ball head 121 to hold the ball stud 112 in place in the pocket 113. The set screw location in the backing clamp 105 can be aligned with the midline of the ball stud 112. The location of the hole 114 and pocket 113 in the backing clamp 105 does not require to be at the center of the backing clamp 105 as shown in FIG. 7C. The center of axis creates the most friction around the ball head 121. The ball stud adjustment lock 124 can be tightened once the operator or passenger has set the best alignment for viewing. Once the initial setup is complete as described in addition the ball stud adjustment lock 124 can be tightened creating a friction lock between the mirror backing clamp 105 and the ball stud 112. Since the design of the cup set screw is rounded it doesn't scratch/mar the ball stud head 121 and this adjustment could be done numerous times without compromising the outer finish of the ball stud 112. The location and or size of the screw can vary around different designs of the mirror backing plate 105 and/or ball stud 112.

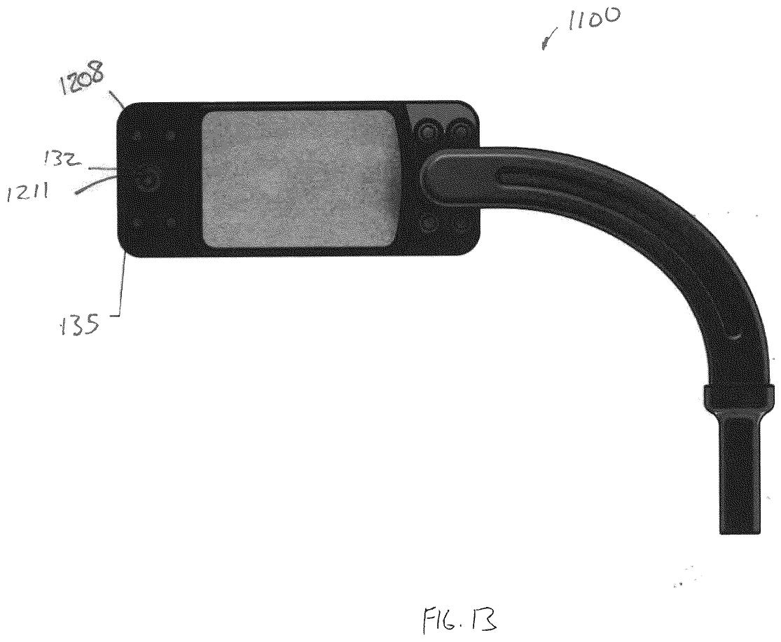

In some embodiments, the vehicle mirror system 200 includes a pivot stud mechanism 116 and needle bearing 126 between the main mirror housing 102 and secondary mirror housing 103 for permitting one of the main mirror housing 102 and secondary mirror housing 103 to rotate about the other of the main mirror housing 102 and secondary mirror housing 103. The pivot stud mechanism 116 is coupled to the main mirror housing 102, for example, slip-fit into a bore 108 or other hole, recess, or the like, of the main mirror housing 102. The pivot stud mechanism 116 may include a dowel or travel limiter 117 that is also press-fit into the main mirror housing 102. The distal end 132 of the pivot stud mechanism 116 can extend through a hole and pocket 135 of the mirror back cap 134 to engage with the needle bearing 126 of the back cap 134. At least a portion of the travel limiter 117 can also be positioned in the pocket 135 to prevent a desirable rotation, torque, or the like between the back cap 134 and main mirror housing 102. For example, the travel limiter 117 can limit an amount of rotation of the secondary mirror 103 to 1-180 degrees. The mirror back cap 134 can be coupled to the secondary mirror housing 105, at an opposite side as the backing clamp 105, by one or more fastening devices, e.g., bolts. In some embodiments, for example, shown in FIGS. 11-13, a shoulder bolt 1202 may be used. Also, the bore 108 in FIG. 5B is replaced in FIGS. 11-13 with a plurality of bores 1208 extending through a main mirror housing 1102 to distribute the weight of the mirror and to support an increased load. The main mirror housing 1102 of FIGS. 11-13 may be otherwise structurally and functionally similar to a main mirror housing 102 of FIGS. 2A-9. A detent assembly 1219 include a ball bearing 1241, etc. similar to the detent assembly 119 of FIGS. 5A and 5B, can be used with respect to the bore 108.

The pivot stud mechanism 116 may include a détent system 119 that can permit the needle bearing 126 to rotate about a rotatable pivot stud 132 extending from the détent system 119 of the pivot stud mechanism 116. As shown in FIGS. 5A and 5B, the detent assembly can include a cap screw, detent spring, at least one ball bearing, a housing, o-ring, set screw, and/or other components that when assembled provides precise angles for the rotating mirror 107, for example, at 20 degree increments. The back cap 134 can contain the needle bearing 126 and detent assembly 119. Some or all components of the detent assembly 119 can be positioned in a threaded bore 125 in the mirror back cap 134. The pivot stud mechanism 116 can include a locating bore 120 that can expose a locking mechanism of the pivot stud 132 for applying a force to control or prevent the rotation of the pivot stud 132. A precision tipped set screw 127 or the like can be threaded into the locating bore 120 to provide a pivot stud lock. The screw 127 can screw into the main mirror housing 102 and be used to fasten and align the main mirror housing 102 and the pivot stud 116. The extending tip can have a slip fit relationship with the alignment hole 120 in the pivot stud lock 127. When tightened, the pivot stud 116 is located in place and cannot rotate. In some embodiments, a set screw 128 can be used as a friction lock by applying a force, e.g., tightening, about the pivot stud lock 127.

Accordingly, when the vehicle mirror system 200 is assembled, for example, shown in FIGS. 2A-2C, the secondary mirror housing 103 and secondary mirror 115 can be used when deemed useful by the operator. The secondary mirror housing 103 and secondary mirror 115 are positioned behind the main mirror housing 102 and rotate around the pivot stud mechanism 116 that is secured to the main mirror housing 102 by the mirror back cap and bolt 118 and washer 129. The needle bearing 126 can be pressed into a hole, indentation, groove or the like of the secondary mirror housing 103 to provide a smooth rotation around the pivot shaft 132. The mirror back cap 134 includes the detent assembly 119 to work in conjunction around the pivot stud 132 to provide locations (degrees or rotation) for the secondary viewing area as well as various increments of viewing through clicks and audible feedback. The detent assembly 119 may include a ball bearing 141, spring 142, and spring backing or set screw 143 which collectively operate to support a weight of the mirror. This configuration provides incredible gains in the field of view, or percentage of what the operator can see behind him or her. These gains can vary based around the external shape and size of the mirror(s). In some embodiments, the secondary mirror 115 adds approximately 175% more view behind the operator per mirror as well as a large number of angles the operator can choose to use between the minimum and maximum rotation the design allows. This new design allows for the operator have an optimal field of view and have the look of the conventional mirror at the same time. When not used the secondary mirror housing 103 simply rests behind the main mirror housing 102 and is stowed away looking seamless.

FIG. 7A is a top view of a backing clamp 105 coupled to a stem 101 of the vehicle mirror system 200 of FIGS. 2-6 by a coupling assembly 700, in accordance with some embodiments. FIG. 7B is a perspective view of the backing clamp 105, stem 101, and ball stud 112 of the coupling assembly 700 of FIG. 7A. FIG. 7C is a perspective view and corresponding close-up view of the coupling assembly 700 of FIGS. 7A and 7B.

The coupling assembly 700 may include the ball stud 112, clamp fasteners 111, and ball stud adjustment lock 124. The ball stud adjustment lock 124, e.g., set screw or the like is constructed and arranged for insertion, i.e., threading, through a hole 130 in the backing clamp 105 (see FIGS. 5A and 5B) and for engaging with the ball shaped head 121 of the ball stud 112 in the pocket 113 of the backing clamp 105. The pocket 113 permits for a rotational movement of the ball stud 112. However, the ball stud adjustment lock 124 when providing a sufficient force against the ball stud 112 can reduce or prevent any rotational movement of the backing clamp 105 and ball stud 112 relative to each other and lock the ball stud 112 against the mirror assembly including the backing clamp 105 and main mirror housing 102

As shown in FIGS. 8A and 8B, the backing clamp 105 may include a plurality of holes 131 positioned about the pocket 113 and hole 114, or or bore, channel or the like. A plurality of clamp fasteners 111, e.g., four (4) bolts, may be positioned through the holes 131 in the backing clamp 105 and be threaded into threaded holes 132 in the main mirror housing 102. When the bolts 111 are tightened, the backing clamp 105 applies a force about, and compresses, the ball stud 112 in the pocket 113 of the main mirror housing 102. A rotational lock element 124, e.g., set screw may provide a secondary locking feature by locking the ball stud 112, backing clamp 105, stem 101, and main mirror housing 102 together.

The configuration shown in FIGS. 8A and 8B allows the various components of the vehicle mirror system 200 to be serviceable, i.e., independent components can be replaced, dissembled, maintained and so on. For example, the ball stud 112 can be removed, i.e., unthreaded, from the stem 101 and replaced. When reassembled, the replacement ball stud 112 can be coupled and held in place between the main mirror housing 102 and backing clamp 105.

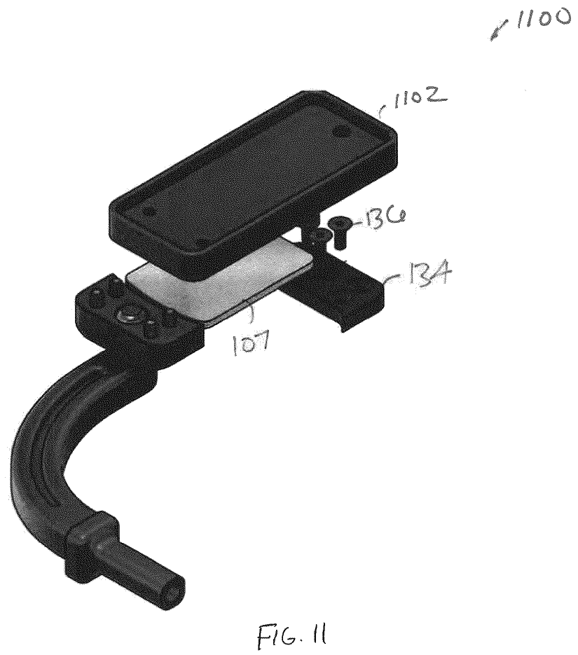

FIG. 9 is a perspective view of a vehicle mirror system 900 in accordance with other embodiments of the present inventive concepts. The vehicle mirror system 900 can include components similar to the vehicle mirror system 200 of FIGS. 2-8, such as the main mirror housing 102, secondary mirror housing 103, and backing claim 105.

In addition, the vehicle mirror system 900 includes a riser block 902 coupled to a distal end of the mirror system 901 by a bolt 903 or other coupling device. The distal end may be attached to the vehicle, for example, a hole in the body of the vehicle, in particular, a stationary component of the vehicle, through which the bolt 903 can be inserted and threaded into the stem 901. The riser block 902 may include a threaded hole 911 for receiving the hollow bolt 903, which can extend through the hole 911 to the mirror stem 901, which also has a threaded hole 921 for receiving an end of the bolt 903. In some embodiments, one or more alignment pins 922 extend from the distal end of the stem 901 for insertion into holes in the riser block 902 to prevent undesirable rotation or torque between the riser block 902 and the stem 901.

In some embodiments, the riser block 902 can extend a length of the mirror stem 901 from the vehicle body to which the stem 101 is attached. In some embodiments, the riser block 902 includes one or more light emitting elements (LED) or the like for providing light. For example, an integrated LED circuit board 905 can be integrated or otherwise be part of the riser block 902 and can serve as running lights, turn signals, brake lights, or other vehicle lights. In doing so, the LED circuit board 905 can be programmed to blink, change intensity, alternate between neighboring LEDs and so on. The riser block 902 may include a wiring outlet 912 or the like for receiving an electrical conduct such as copper wire for providing power and/or control signals to the LED circuit board 905. In some embodiments, the bolt 903 is hollow or other includes a bore or hole 904 extending through its length for providing a wiring outlet from the vehicle to the LED circuit board 905.

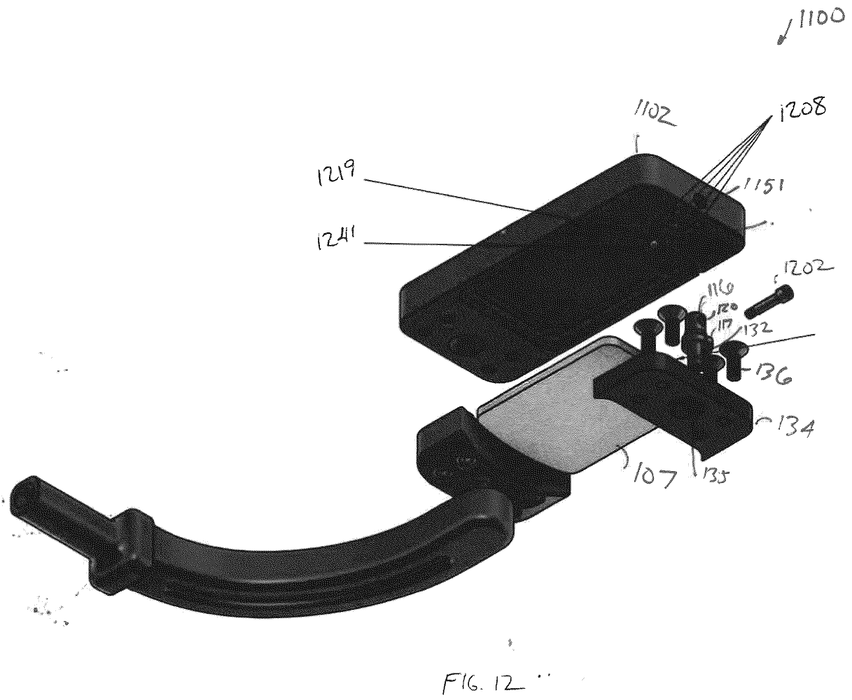

FIGS. 10A and 10B are views of a vehicle mirror system 1000 in a closed and open position, in accordance with other embodiments of the present inventive concepts. The vehicle mirror system 1000 can include components similar to the vehicle mirror system 200 of FIGS. 2-8, such as the main mirror housing 102, secondary mirror housing 103, and backing claim 105 and therefore details thereof are not repeated for brevity.

In addition, the mirror stem 1001 can include a plurality of LEDs 1041 or the like. A smoked or clear lens 1043 can be positioned over the LEDs 1041 of the stem 1001. Another lens 1016 can be positioned over the LEDs 1015 of the main mirror housing 1002. The LEDs can be powered by a power source external to the stem 1041 or in the housing 1002, or external to the system 1000, for example, a power source such as a battery in the vehicle. In some embodiments, the stem 101 shown in FIG. 8B includes a groove 141 or the like in which the LEDs 1041 can be positioned. The LEDs 1041 can be attached to the stem 1001 by fastening elements 1042 such as screws, adhesive, and so on. In some embodiments, the stem 1001 and/or housing 1002 can include solar panels or the like for providing alternative energy to the LEDs 1041. A wire or other conduit (not shown) can extend through the stem 1001 to provide power to the LEDs 1041. In some embodiments, a bolt 1013 holding a riser 1012 in place against the stem 1001 includes a hole 1014, or bore, channel or the like extending through its length for providing a wiring outlet from the vehicle to the LED circuit board.

An integrated circuit board comprising a plurality of LEDs 1015 can be integrated or otherwise be part of the stem 1001 and/or main mirror housing 1002 and/or secondary mirror 1003 and can serve as running lights, turn signals, brake lights, or other vehicle lights. In doing so, the LED circuit board can be programmed to blink, change intensity, alternate between neighbouring LEDs and so on. The LED circuit board may be part of the main mirror housing 1012. The stem 1001 may include a wiring outlet or the like for receiving an electrical conduct such as copper wire for providing power and/or control signals to the LED circuit board.

As shown in FIG. 10A, the secondary mirror housing 1003 may include a plurality of

LEDs 1013, for example, arranged in three rows or other array arrangement. The LED lights 1013 are arranged to provide additional visibility for other drivers to see the vehicle on which the system 1000 is mounted, or to see at least the mirror housing 1003 on which the LEDs 1013 are positioned. In some embodiments, the LEDs 1013 can operate as running lights, directional lights, or other light-related functions used in vehicles. When the secondary mirror is rotated, for example, shown in FIG. 10B, the LEDs 1013 are moved further away from the vehicle or the center line or the operator. In some embodiments, the secondary mirror housing 1003 can be similar to the mirror housing 103 shown in FIG. 5B including grooves 133 or the like in which the LEDs 1013 can be positioned. The LEDs 1013 can be attached to the ssecondary mirror housing 1003 by fastening elements such as screws, adhesive, and so on. In some embodiments, the housing 1003 or the vehicle itself can include solar panels or the like for providing alternative energy to the LEDs 1013. A wire or other conduit (not shown) can extend through the housing 1003 to provide power to the LEDs 1013.

The mirror system 1000 can include a riser 1012 similar to the riser 902 of FIG. 9. However, the riser 1012 may have a different shape, namely, including a recessed pocket 1021 that mates with the distal end of the stem 1001 to prevent undesirable rotation between the stem 1001 and the riser 1012.

In some embodiments, the secondary mirror housing 1003 may include holes 1013A instead of LEDs 1013 shown in FIG. 10A. The holes 1013A can permit light from LEDs 1015 coupled to the main mirror housing 102 to be seen through the holes 1013A when the system 1000 is in a closed state as shown in FIG. 10A. In other embodiments, in the open state shown in FIG. 10B the system 1000 includes both LEDs 1013 emitting light from the secondary mirror housing 103 and LEDs 1015 emitting light from the main mirror housing 102. Here, in the closed state shown in FIG. 10A, only the LEDs 1013 can be seen since the secondary mirror housing 103 blocks or obscures the LEDs 1015 of the main mirror housing 102. The LEDs 1013 and/or 1015 can be powered by a wire conduit or the like coupled to a power source either part of the system 1000 or the vehicle to which the system 1000 is coupled. In some embodiments, the system 1000 includes a switching element, e.g., a microswitch, that senses a rotation of the secondary mirror housing 103 about the main mirror housing 102, for example, transitioning from the closed state shown in FIG. 10A to the open state shown in FIG. 10B. Here, the switch can provide power to the LEDs to automatically power the LEDs in response to the rotation when the secondary mirror is used.

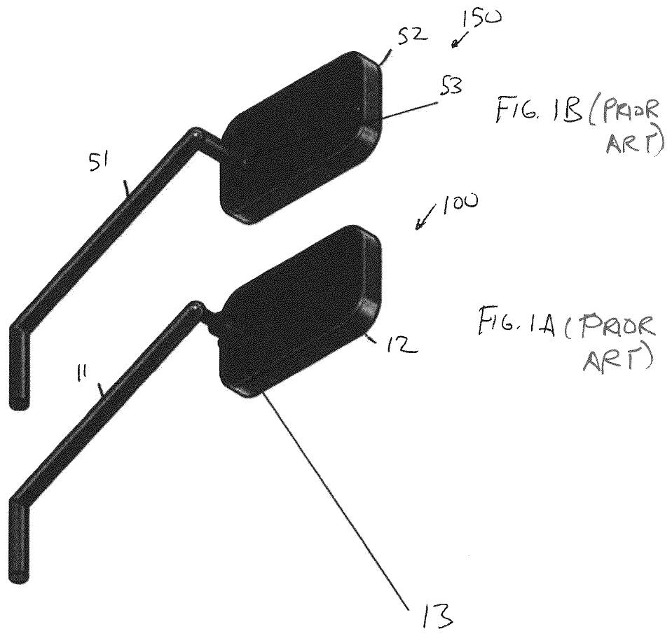

Referring again to the mirror system of FIGS. 11-13, the mirror system 1100 includes components similar to those of the embodiments of FIGS. 1-10 and are not repeated for brevity. In addition, as described above, the main mirror housing 1102 may include a plurality of holes 1208, e.g., four bores, for a spring and ball bearing 1241 of the detent assembly 1219. The rotating mirror back cap can be coupled to the main mirror housing to apply a force on the ball bearings and springs of the detent assembly 1219, in particular, the ball bearings pressed against the pockets in the rotating mirror back. The ball bearings 1241 can be aligned about an axis of extension, setting the desired movement and achieving a click-type noise adjustment offered by the detent assembly.

As shown in FIG. 13, a cam element 1211 can be on the pivot stud 132 to limit rotation by contacting the rotating housing 1102. In some embodiments, the housing 1102 can rotate relative to the mirror back cap 134 but is not limited thereto. For example, rotation may be limited to a range of 0-180 degrees.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

What is claimed is:

1. A mirror system, comprising:
a main mirror housing;
a main mirror coupled to a first side of a main mirror housing;
a mirror stem having a distal end coupled to a surface of a vehicle;
a backing clamp between a proximal end of the mirror stem and a second side of the main mirror housing, the backing clamp including a pocket aligned with a threaded hole at the distal end of the mirror stem, the backing clamp permitting the main mirror to rotate about the mirror stem;
a secondary mirror housing; and
a secondary mirror coupled to a first side of the secondary mirror housing.

2. The mirror system of claim 1, further comprising:
a ball stud extending from the pocket in the backing clamp to the threaded hole at the distal end of the mirror stem.

3. The mirror system of claim 1, further comprising a secondary mirror system movably coupled to a second side of the main mirror housing, the secondary mirror system constructed and arranged to rotate relative to a surface of the main mirror housing.

4. The mirror system of claim 2, comprising:
a rotating mirror back cap between a first side of the secondary mirror system and the second side of the main mirror housing; and
a pivot stud between the secondary mirror system and the main mirror about which one of the secondary mirror system and the main mirror rotates relative to the other of the secondary mirror system and the main mirror.

5. The mirror system of claim 3, wherein the rotating mirror back cap includes a detent assembly about the pivot stud allowing the one of the secondary mirror system and the main mirror to rotate incrementally relative to the other of the secondary mirror system and the main mirror.

6. The mirror system of claim 1, further comprising an adjustment locking device positioned in the pocket of the backing clamp (5) for applying a locking action on the ball stud.

7. The mirror system of claim 1, wherein the ball stud is constructed and arranged to be removed from the mirror stem and the backing clamp is dissembled from the main mirror housing.
